(19) United States
(12) Patent Application Publication
(10) Pub. No.: US 2011/0026365 A1
(43) Pub. Date: Feb. 3, 2011

(54) ULTRASONIC TRANSDUCER AND SIGNAL DECAY TIME ADJUSTING METHOD APPLIED THERETO

(75) Inventors: Steef van Beckhoven, Eindhoven (NL); Johan Kalfs, Eindhoven (NL); Michel Klein Swormink, Eindhoven (NL); Hanting Chen, Hsinchu (TW); Sian-Cing Liao, Hsinchu (TW)

Correspondence Address: WPAT, PC;INTELLECTUAL PROPERTY ATTORNEYS, 7225 BEVERLY ST., ANNANDALE, VA, 22003, US

(73) Assignee: LITE-ON IT CORP., Taipei City (TW)

(21) Appl. No.: 12/847,045

(22) Filed: Jul. 30, 2010

(30) Foreign Application Priority Data
Jul. 30, 2009 (CN) 200910160224.8

(51) Int. Cl. G01S 7/524; G01S 7/527

(52) U.S. Cl. 367/137; 367/135; 367/903

(57) ABSTRACT

A signal decay time adjusting method is used in an ultrasonic transducer. Firstly, a first driving signal is generated by a pre-processing module. When the first driving signal is received, an ultrasonic transmitting/receiving module generates vibration and transmits a sensing wave according to the first driving signal. Then, the pre-processing module stops generating the first driving signal so that the vibration generated within the ultrasonic transmitting/receiving module is decayed as a decay signal. Then, a second driving signal is generated by the pre-processing module according to the first driving signal, and the second driving signal is transmitted to the ultrasonic transmitting/receiving module. When the second driving signal is received, the decay signal is offset according to the second driving signal, so that a decay time of the decay signal is shortened. When the sensing wave is reflected by an object, a reflective wave is received by the ultrasonic transmitting/receiving module.

### FIELD OF THE INVENTION

The present invention relates to an ultrasonic transducer, and more particularly to an ultrasonic transducer having a function of adjusting a signal decay time. The present invention also relates to signal decay time adjusting method applied to the ultrasonic transducer. By adjusting the phase, amplitude, pulse number and frequency of a driving signal, the decay time of a decay signal generated within the ultrasonic transducer is quickly reduced.

### BACKGROUND OF THE INVENTION

An ultrasonic transducer is a device that converts energy into ultrasonic waves. A conventional ultrasonic transducer is used for generating single-frequency ultrasonic waves. Another type of ultrasonic transducer contains two independently operated elements in a single housing, wherein one of the elements is a transmitter, and the other is a receiver. That is, a transmitter and a receiver are included in the ultrasonic transducer. The transmitter and the receiver face the same side to transmit an ultrasonic wave and receive the reflective wave, respectively. For determining the distance from an object to the ultrasonic transducer, the ultrasonic transducer generates a high frequency ultrasonic wave and evaluates the reflective wave which is returned back to the ultrasonic transducer. When the reflective wave is received, the ultrasonic transducer will calculate the time interval between generation of the ultrasonic wave and receipt of the reflective wave.

Conventionally, the transmitter of the ultrasonic transducer is formed of a piezoelectric film. The piezoelectric film is driven to generate vibration in response to a driving signal having constant amplitude and about 40 KHz frequency. Due to the mechanical property of vibration, the piezoelectric film does not stop vibrating in a short time period after the driving signal is stopped. As such, a ringing phenomenon occurs. Although the vibration of the piezoelectric film is gradually decayed during this time period, a decay signal with a corresponding waveform is generated. Since the transmitter and the receiver of the ultrasonic transducer are included in the same module, after the reflective wave is received by the receiver, the reflective wave may vibrate the piezoelectric film to generate an echo signal with a corresponding waveform. If the distance between the ultrasonic transducer and the object is too short, the waveform or decay signal resulted from the ringing phenomenon has adverse influences on the performance of receiving the reflective wave.

FIG. 1 is a schematic timing waveform diagram illustrating associated signals of an ultrasonic transducer for distance determination according to the prior art. In response to a driving signal DS (in the lower-left part of the drawing), the piezoelectric film within the ultrasonic transducer generates corresponding vibration. The vibration of the piezoelectric film has a waveform of an oscillation signal OS (in the upper-left part of the drawing). In response to the oscillation signal OS, the ultrasonic transducer generates and transmits an ultrasonic wave. At the time spot t0, the driving signal DS is stopped and a ringing phenomenon occurs. Due to the ringing phenomenon, the oscillation signal OS is not immediately stopped but the amplitude thereof is gradually decreased as a decay signal RS. When the oscillation signal OS is reflected by an object, an echo signal ES (in the right part of the drawing) is returned back to the ultrasonic transducer.

For avoiding erroneous judgment resulted from noise, a threshold level L is employed as a criterion for judging whether the object is actually detected. For example, the threshold level L is 1V or any other value. In a case that the amplitude of the echo signal ES is greater than the threshold level L, the ultrasonic transducer may judge that an object is detected within the sensing range. At the time spot t2 when the amplitude of the echo signal ES just reaches the threshold level L, the object is detected. According to the time spot t2, the distance between the ultrasonic transducer and the object is calculated.

The time interval from termination of the driving signal DS to the time spot when the oscillation signal OS is reduced to the threshold level L is called as a dead zone Zd. In other words, after the amplitude of the decay signal RS is smaller than the threshold level L (the time spot t1), the influence of the decay signal RS on receiving the echo signal ES is considered to be negligible.

On the other hand, if the distance of the object from the ultrasonic transducer is too short, the time interval between generation of the ultrasonic wave and receipt of the reflective wave is very small. As such, the echo signal ES is very close to the decay signal RS, or the time spot of receiving the echo signal ES is earlier than the time spot when the decay signal RS is reduced to the threshold level L (i.e. decaying completion of the decay signal RS). Since the transmitter and the receiver are included in the same ultrasonic transducer or transmitting/receiving module, it is impossible to differentiate the echo signal ES and the decay signal RS if the echo signal ES and the decay signal RS are mixed.

FIG. 2 is a schematic timing waveform diagram illustrating associated signals of an ultrasonic transducer for distance determination according to the prior art, in which the echo signal and the decay signal are mixed. As shown in FIG. 2, the amplitude of the decay signal RS is smaller than the threshold level L at the time spot t1. The decay time is so long that the range of the dead zone Zd is very wide. In addition, since the distance between the object and the ultrasonic transducer is too short, the time spot of receiving the echo signal ES (at the time spot t2) is earlier than the time spot when the decay signal RS is reduced to the threshold level L (at the time spot t1). In other words, the echo signal ES and the decay signal RS are mixed. Under this circumstance, the processor fails to clearly judge the time spot of receiving the reflective wave and the corresponding waveform. Due to the limitation of the dead zone Zd, the ultrasonic transducer is not effective for determining the distance to a nearby object.

Therefore, there is a need of providing a device and a method for reducing the dead zone Zd.

### SUMMARY OF THE INVENTION

The present invention provides an ultrasonic transducer and a signal decay time adjusting method for reducing the decay time of the decay signal and quickly reaching the decaying completion of the decay signal by adjusting the phase, amplitude, pulse number and frequency of the driving signal.

In accordance with an aspect of the present invention, there is provided a signal decay time adjusting method for use in an ultrasonic transducer. The ultrasonic transducer includes a pre-processing module and an ultrasonic transmitting/receiving module. Firstly, a first driving signal is generated by the pre-processing module. When the first driving signal is received, the ultrasonic transmitting/receiving module generates vibration and transmits a sensing wave according to the first driving signal. Then, the pre-processing module stops generating the first driving signal so that the vibration generated within the ultrasonic transmitting/receiving module is decayed as a decay signal. Then, a second driving signal is generated by the pre-processing module according to the first driving signal, and the second driving signal is transmitted to the ultrasonic transmitting/receiving module. When the second driving signal is received by the ultrasonic transmitting/receiving module, the decay signal is offset according to the second driving signal so that a decay time of the decay signal is shortened. When the sensing wave is reflected by an object, a reflective wave is received.

In accordance with another aspect of the present invention, there is provided an ultrasonic transducer having a function of adjusting a signal decay time. The ultrasonic transducer includes a pre-processing module and an ultrasonic transmitting/receiving module. The pre-processing module is used for generating a first driving signal, and generating a second driving signal according to the first driving signal after the first driving signal is stopped. The ultrasonic transmitting/receiving module is in communication with the pre-processing module for receiving the first driving signal, and generating vibration and transmitting a sensing wave according to the first driving signal. The second driving signal is received by the ultrasonic transmitting/receiving module after the pre-processing module stops generating the first driving signal. The vibration generated within the ultrasonic transmitting/receiving module is decayed as a decay signal, and the decay signal is offset according to the second driving signal so that a decay time of the decay signal is shortened. A reflective wave is further received by the ultrasonic transmitting/receiving module when the sensing wave is reflected by an object.

### BRIEF DESCRIPTION OF THE DRAWINGS

The above contents of the present invention will become more readily apparent to those ordinarily skilled in the art after reviewing the following detailed description and accompanying drawings, in which:

FIG. 1 is a schematic timing waveform diagram illustrating associated signals of an ultrasonic transducer for distance determination according to the prior art;

FIG. 2 is a schematic timing waveform diagram illustrating associated signals of an ultrasonic transducer for distance determination according to the prior art, in which the echo signal and the decay signal are mixed;

FIG. 3 is a schematic functional block diagram illustrating an ultrasonic transducer according to an embodiment of the present invention;

FIG. 4A is a schematic timing waveform diagram illustrating associated signals of the ultrasonic transducer according to an embodiment of the present invention, in which the second driving signal is not generated;

FIG. 4B is a schematic timing waveform diagram illustrating associated signals of the ultrasonic transducer according to an embodiment of the present invention, in which the second driving signal is generated;

FIG. 5 is a schematic timing waveform diagram illustrating the first driving signal DS1 and the second driving signal DS2 generated by the pre-processing module according to the present invention; and

FIG. 6 is a flowchart illustrating a signal decay time adjusting method according to the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

As previously described, the piezoelectric film within the ultrasonic transducer generates corresponding vibration and transmits a sensing wave. When the driving signal is stopped, the waveform of the decay signal has a dead zone, which is detrimental for processing and receiving the echo signal. The influence on the performance of processing and receiving the echo signal is dependent on the length of the dead zone. As the dead zone is widened, the scope of application of the ultrasonic transducer is reduced. If the dead zone is zero, even a nearby object can be detected by the ultrasonic transducer. In other words, the decay time of the decay signal may be reduced or the decay signal may quickly reach the threshold value if the dead zone is shortened. In a case that the dead zone is shortened, the ultrasonic transducer is able to determine a nearby object. Therefore, the present invention provides an ultrasonic transducer and a signal decay time adjusting method for obviating the drawbacks encountered from the prior art.

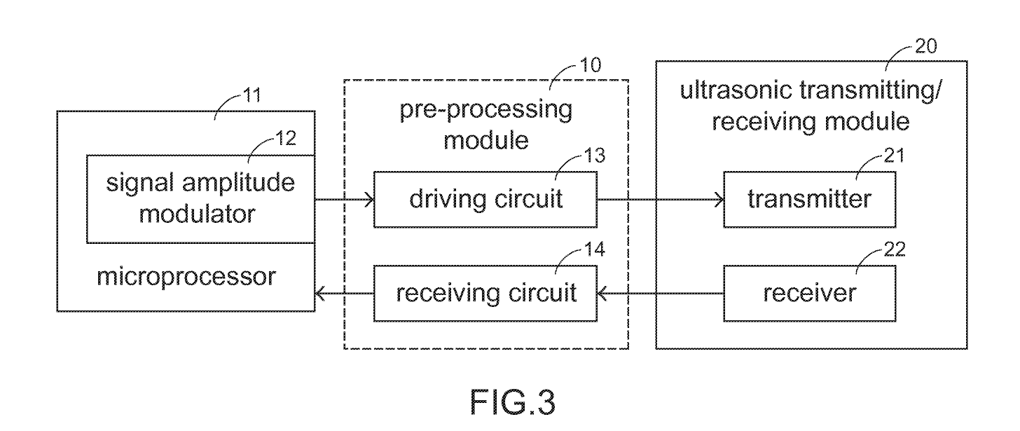

FIG. 3 is a schematic functional block diagram illustrating an ultrasonic transducer according to an embodiment of the present invention. As shown in FIG. 3, the ultrasonic transducer 100 comprises a microprocessor 11, a pre-processing module 10 and an ultrasonic transmitting/receiving module 20. The microprocessor 11 comprises a signal amplitude modulator 12. The pre-processing module 10 comprises a driving circuit 13 and a receiving circuit 14. The ultrasonic transmitting/receiving module 20 comprises a transmitter 21 for transmitting an ultrasonic wave and a receiver 22 for receiving a reflective wave. This drawing also indicates the relationship between these components. The ultrasonic transducer 100 can determine the distance between an object (not shown) and the ultrasonic transducer 100. Without any additional component, the ultrasonic transducer of the present invention provides specified driving signals with specified waveform relations in order to shorten or adjust the decay time of the decay signal.

The pre-processing module 10 is used for generating a driving signal. The ultrasonic transmitting/receiving module 20 is used for transmitting an ultrasonic wave and receiving an echo signal by the receiver 22. The driving signal is outputted to the transmitter 21 of the ultrasonic transmitting/receiving module 20. The transmitter 21 is formed of a piezoelectric film. During operation of the transmitter 21, a ringing phenomenon occurs within the ultrasonic transmitting/receiving module 20. Since the ultrasonic transmitting/receiving module 20 has the dual functions of transmitting and receiving ultrasonic waves, the echo signal corresponding to the reflective wave and the decay signal resulted from the ringing phenomenon will be mixed together if the object is nearby the ultrasonic transducer 100.

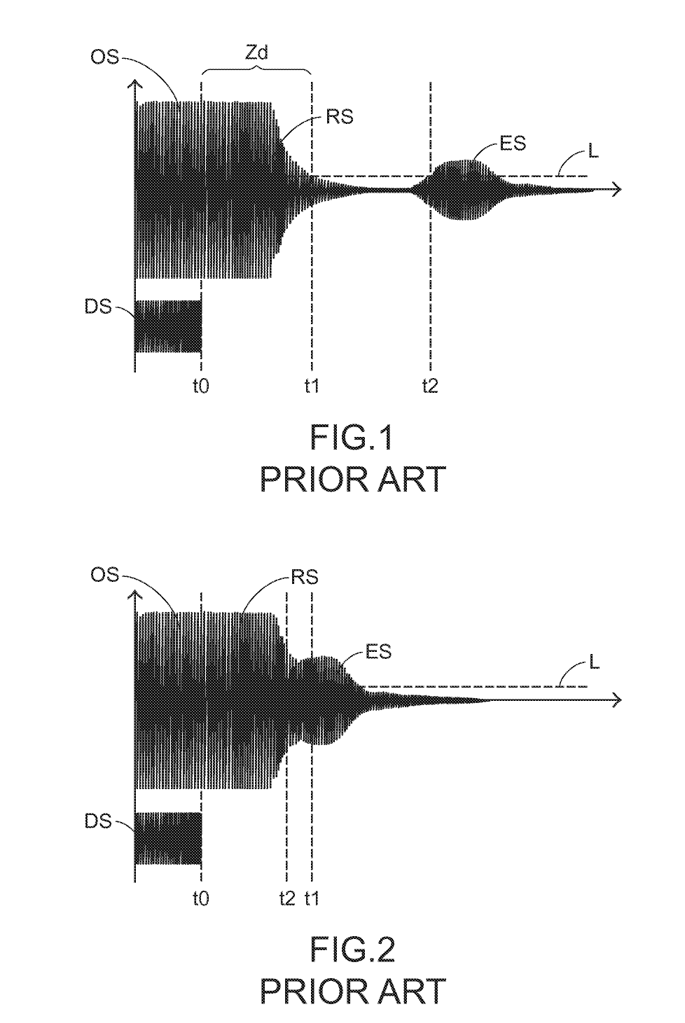

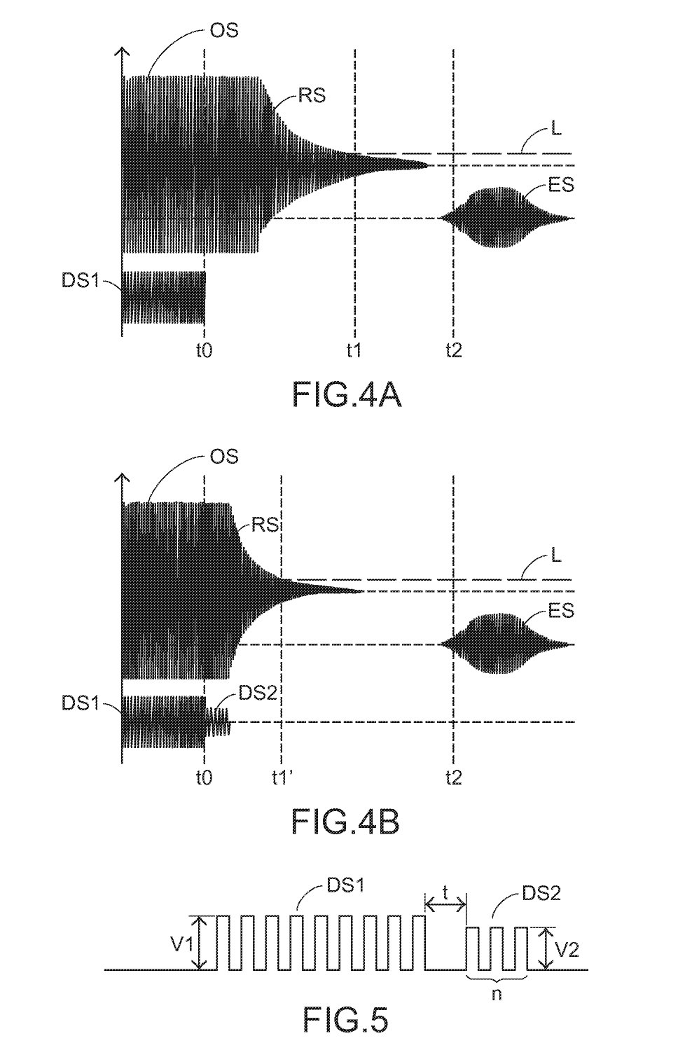

The advantage of a signal decay time adjusting method applied to the ultrasonic transducer will be illustrated with reference to FIGS. 4A and 4B. FIG. 4A is a schematic timing waveform diagram illustrating associated signals of the ultrasonic transducer according to an embodiment of the present invention, in which the second driving signal is not generated. FIG. 4B is a schematic timing waveform diagram illustrating associated signals of the ultrasonic transducer according to an embodiment of the present invention, in which the second driving signal is generated. For clarification, the driving signals, the oscillation signals, the decay signals and the echo signals included in these two drawings are separately shown. In practice, the decay signals and corresponding echo signals are in the same time axis. The definition of the threshold level L is identical to that described in FIGS. 1 and 2, and is not redundantly described herein.

Firstly, a first driving signal DS1 is generated by the pre-processing module 10. When the first driving signal DS1 is received by the transmitter 21 of the ultrasonic transmitting/receiving module 20, the transmitter 21 generates corresponding vibration. The vibration has a waveform of an oscillation signal OS and generates a sensing wave. As shown in FIG. 3, the signal amplitude modulator 12 of the microprocessor 11 is able to control the first driving signal DS1. That is, the frequency, amplitude or duty cycle of the first driving signal DS1 may be controlled by the signal amplitude modulator 12 (or the microprocessor 11). After processed by the signal amplitude modulator 12 (or the microprocessor 11), the driving circuit 13 outputs the first driving signal DS1. Please refer to FIG. 4A. At the time spot t0, the pre-processing module 10 stops outputting the first driving signal DS1. Due to the ringing phenomenon occurring within the ultrasonic transmitting/receiving module 20, the oscillation signal OS is not immediately stopped but the amplitude thereof is gradually decreased as a decay signal RS. Since the distribution area of the decay signal RS is relatively large, it is meant that a longer time period is required for the decaying completion of the decay signal RS.

After a second driving signal DS2 is generated by the pre-processing module 10 and transmitted to the ultrasonic transmitting/receiving module 20, the waveforms of associated signals are shown in FIG. 4B. In accordance with a key feature of the present invention, the characteristics of the second driving signal DS2 is determined by the microprocessor 11 according to the first driving signal DS1. In particular, the first driving signal DS1 and the second driving signal DS2 have different phases. In a case that the oscillation signal OS corresponding to the first driving signal DS1 is in a decaying status and the decay signal RS is created, the phase of the initial part of the decay signal RS is substantially equal to the phase of the oscillation signal OS. After the second driving signal DS2 is received by the ultrasonic transmitting/receiving module 20, the vibrating energy of the decay signal RS will be offset because the first driving signal DS1 and the second driving signal DS2 have different phases.

In a case that the first driving signal DS1 and the second driving signal DS2 are out of phase, the vibrating energy offset efficacy is optimized. In one embodiment, the second driving signal DS2 has a phase shift with respect to the first driving signal DS1. The phase shift is determined by the microprocessor 11 according to the first driving signal DS1. The magnitude of the phase shift is not restricted as long as the energy of the decay signal RS in the vibrating direction is offset rather than magnified. In other words, the magnitude of the phase shift is selected such that decay time of the decay signal RS is shortened.

In an embodiment, the first driving signal DS1 and the second driving signal DS2 have the same frequency. As such, the vibrating energy of the decay signal RS in the vibrating direction is offset according to the phase difference between the first driving signal DS1 and the second driving signal DS2. In one embodiment, the first driving signal DS1 and the second driving signal DS2 have different frequencies. The frequency of the second driving signal DS2 is not restricted as long as the vibrating energy of the decay signal RS in the vibrating direction is offset by means of the second driving signal DS2. Similarly, the process of setting the frequency of the second driving signal DS2 is implemented by the means of the microprocessor 11.

In addition to the phase or frequency, the amplitude of the second driving signal DS2 can be adjusted by the signal amplitude modulator 12. The amplitudes of the first driving signal DS1 and the second driving signal DS2 may be identical or different. In a case that the amplitudes of the first driving signal DS1 and the second driving signal DS2 are different, the vibrating energy of the decay signal RS could be uniformly and stably offset.

In an embodiment, the amplitude of the second driving signal DS2 is set to be smaller than or slightly smaller than that of the first driving signal DS1. As such, the vibrating energy of the decay signal RS could be uniformly, stably and quickly decayed. In one embodiment, the amplitude of the second driving signal DS2 is set to be equal to that of the first driving signal DS1. Correspondingly, the driving time, phase or frequency of the second driving signal DS2 should be adjusted to reduce the negative influence of the ringing phenomenon. Similarly, the process of adjusting the driving time, phase or frequency of the second driving signal DS2 is implemented by the means of the microprocessor 11. In one embodiment, the amplitude of the second driving signal DS2 is set to be greater than that of the first driving signal DS1. By means of a proper controlling mechanism, the decay time of the decay signal RS is shortened while reducing the negative influence of the ringing phenomenon.

Moreover, the driving time is another important controlling parameter. In particular, the driving time of the second driving signal DS2 can be adjusted by setting number of cyclic pulses included in the waveform of the second driving signal DS2. In an embodiment, the first driving signal DS1 and the second driving signal DS2 have different phases. The formation or the waveform distribution of the decay signal RS is related to the first driving signal DS1 or the corresponding oscillation signal OS. As shown in FIG. 4A, although the waveform of the decay signal RS is slowly decreased, the pulse number included in the decaying waveform is relatively larger.

Please refer to FIG. 4B again. The amplitude of the second driving signal DS2 is kept constant. If the number of cyclic pulses included in the waveform of the second driving signal DS2 is not in relation with the pulse number of the decay signal RS, the energy offset efficacy is unsatisfied. For example, the pulse number of the second driving signal DS2 is too low, the second driving signal DS2 is insufficient to well offset the energy of the decay signal RS. On the other hand, if the pulse number of the second driving signal DS2 is too high, the ringing phenomenon is strengthened. Therefore, the number of cyclic pulses included in the waveform of the second driving signal DS2 should be properly determined. The process of setting the pulse number of the second driving signal DS2 is implemented by the microprocessor 11.

FIG. 5 is a schematic timing waveform diagram illustrating the first driving signal DS1 and the second driving signal DS2 generated by the pre-processing module 10 according to the present invention. For clarification, the first driving signal DS1 and the second driving signal DS2 are shown as rectangular waves in this drawing. Nevertheless, the first driving signal DS1 and the second driving signal DS2 can be sine waves or triangle waves. As shown in FIG. 5, the amplitude V2 of the second driving signal DS2 is smaller than the amplitude V1 of the first driving signal DS1. The second driving signal DS2 is generated after the first driving signal DS1, and there is a time interval t between a start point of the second driving signal DS2 and an end point of the first driving signal DS1. In this embodiment, the first driving signal DS1 and the second driving signal DS2 have the same frequency. The pulse number n of the second driving signal DS2 is three. Of course, the pulse number n of the second driving signal DS2 may be set or adjusted according to the practical requirements.

The second driving signal DS2 and/or the first driving signal DS1 are generated under the control of the microprocessor 11. That is, specified parameters or conditions (e.g. phases, frequencies, pulse numbers, amplitudes, and the like) of the second driving signal DS2 and/or the first driving signal DS1 are processed or adjusted by the microprocessor 11 including the signal amplitude modulator 12. The first driving signal DS1 and the second driving signal DS2 with the processed or adjusted parameters or conditions are outputted from the driving circuit 13. These driving signals are transmitted to the ultrasonic transmitting/receiving module 20, and thus the ultrasonic transmitting/receiving module 20 generates corresponding vibration.

From the above discussion, the second driving signal DS2 may be considered as brake pulses for offsetting the vibrating energy of the first driving signal DS1 or the decay signal RS. In other words, the brake pulses may force the piezoelectric film (i.e. the transmitter 21) to instantly stop vibration. By generating vibrating waveforms in opposite directions to the piezoelectric film, the piezoelectric film is quickly switched from the vibrating status to a static status, and thus the decay time of the decay signal RS is largely reduced. As shown in FIG. 4B, the decay signal RS is quickly decayed, and thus the echo signal ES and the decay signal RS can be effectively differentiated. The decaying completion of the decay signal RS is reached at the time spot t1′ for the waveform of FIG. 4B. Whereas, the decaying completion of the decay signal RS is reached at the time spot t1 for the waveform of FIG. 4A. Since the time spot of reaching the decaying completion of the decay signal RS appears earlier according to the present invention, the dead zone is largely narrowed in comparison with the prior art technology.

The ultrasonic transducer 100 of the present invention can be used to determine the distance of an object relative to the ultrasonic transducer 100. According to the first driving signal DS1, the transmitter 21 of the ultrasonic transmitting/receiving module 20 generates the sensing wave. Once the sensing wave is reflected by an object, a reflective wave is returned back to the ultrasonic transducer 100 and received by the receiver 22 of the ultrasonic transmitting/receiving module 20. The waveform of the reflective wave is illustrated by referring to the echo signals ES (see FIGS. 4A and 4B). Please refer to FIG. 4B. Before the amplitude of the echo signal ES just reaches the threshold level L (at the time spot t2), the decaying completion of the decay signal is already reached. As a consequence, the echo signal ES and the decay signal RS can be effectively differentiated.

After the reflective wave is received by the receiver 22, the receiver 22 will output an echo signal ES, which is indicative of the reflective wave. Please refer to FIG. 3 again. The ultrasonic transducer 100 further comprises a receiving circuit 14. The receiving circuit 14 is in communication with the receiver 22 for receiving the echo signal ES. According to the echo signal ES, the distance between the ultrasonic transducer 100 and the object can be determined. Moreover, by the receiving circuit 14, the echo signal ES may be converted into a piezoelectric signal in order to determine the receiving time. The process of determining the receiving time is implemented by the microprocessor 11 or other suitable processing unit of the ultrasonic transducer 100. The method of processing or calculating the distance between ultrasonic transducer 100 and the object is similar to that described in the prior art. That is, the distance between the ultrasonic transducer 100 and the object is determined according a time interval from generation of the sensing wave and receipt of the reflective wave.

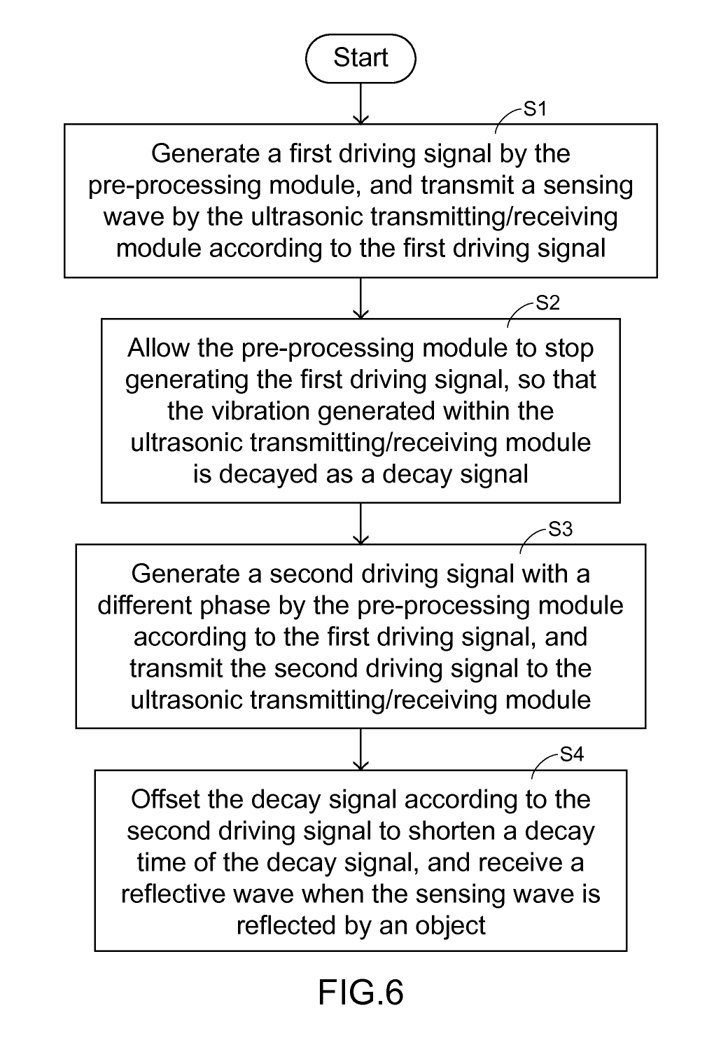

FIG. 6 is a flowchart illustrating a signal decay time adjusting method according to the present invention. Firstly, a first driving signal DS1 is generated by the pre-processing module 10. When the first driving signal DS1 is received by the ultrasonic transmitting/receiving module 20, the ultrasonic transmitting/receiving module 20 generates corresponding vibration and transmits a sensing wave (Step S1). Then, the pre-processing module 10 stops generating the first driving signal DS1, so that the vibration generated within the ultrasonic transmitting/receiving module 20 is decayed as a decay signal RS (Step S2). According to the first driving signal DS1, a second driving signal DS2 with a different phase is generated by the pre-processing module 10 and transmitted to the ultrasonic transmitting/receiving module 20 (Step S3). After the second driving signal DS2 is received by the ultrasonic transmitting/receiving module 20, the ultrasonic transmitting/receiving module 20 generates vibration to offset the decay signal RS according to the second driving signal DS2, thereby reducing the decay time of the decay signal RS. Afterwards, a reflective wave generated when the sensing wave is reflected by an object is received by the ultrasonic transmitting/receiving module 20 (Step S4).

The driving signals used in the ultrasonic transducer of the present invention may be generated from a control unit that is commonly used in the conventional ultrasonic transducer technology. In addition, the parameters (e.g. phases or amplitudes) of the corresponding signals may be controlled by such a control unit. As a consequence, the present invention can achieve the purposes of adjusting and controlling the signal decay time without any additional component or cost. The signal decay time adjusting method of the present invention may be implemented by a program. Alternatively, the signal decay time adjusting method of the present invention may be implemented by chips of corresponding components. After the chips are fabricated, the components containing the chips are tested and associated parameters are predetermined in these components. For example, the phase, frequency, amplitude or pulse number of the second driving signal may be predetermined in order to achieve an optimized application.

From the above description, the ultrasonic transducer and the signal decay time adjusting method of the present invention are capable of reducing the decay time of the decay signal and quickly reaching the decaying completion of the decay signal by adjusting the phase, amplitude, pulse number and frequency of the second driving signal. Since the dead zone is narrowed, the degree of mixing the echo signal with the decay signal is reduced. Under this circumstance, the echo signal and the decay signal can be effectively differentiated. Moreover, since the dead zone is narrowed, the ultrasonic transducer of the present invention is effective for determining the distance of a nearby object.

While the invention has been described in terms of what is presently considered to be the most practical and preferred embodiments, it is to be understood that the invention needs not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A signal decay time adjusting method for an ultrasonic transducer, the ultrasonic transducer comprising a pre-processing module and an ultrasonic transmitting/receiving module, the signal decay time adjusting method comprising steps of:
generating a first driving signal by the pre-processing module;
generating vibration and transmitting a sensing wave by the ultrasonic transmitting/receiving module according to the first driving signal when the first driving signal is received;
stopping generating the first driving signal so that the vibration generated within the ultrasonic transmitting/receiving module is decayed as a decay signal;
generating a second driving signal by the pre-processing module according to the first driving signal, and transmitting the second driving signal to the ultrasonic transmitting/receiving module;
offsetting the decay signal according to the second driving signal when the second driving signal is received by the ultrasonic transmitting/receiving module so that a decay time of the decay signal is shortened; and
receiving a reflective wave when the sensing wave is reflected by an object.

2. The signal decay time adjusting method according to claim 1, further comprising a step of determining a distance between the ultrasonic transducer and the object according to a time interval from generation of the sensing wave and receipt of the reflective wave.

3. The signal decay time adjusting method according to claim 1 wherein the first driving signal has a first phase, a first amplitude, a first pulse number and a first frequency, and the second driving signal has a second phase, a second amplitude, a second pulse number and a second frequency.

4. The signal decay time adjusting method according to claim 3, further comprising a step of setting the second amplitude to be equal to the first amplitude.

5. The signal decay time adjusting method according to claim 3 wherein the second frequency is equal to the first frequency, and there is a phase shift between the second phase and the first phase.

6. The signal decay time adjusting method according to claim 5, further comprising a step of setting the phase shift such that the second driving signal and the first driving signal have different phases or they are out of phase.

7. The signal decay time adjusting method according to claim 3 wherein the second frequency and the first frequency are different.

8. The signal decay time adjusting method according to claim 3, further comprising a step of setting the second pulse number.

9. An ultrasonic transducer having a function of adjusting a signal decay time, the ultrasonic transducer comprising:
a pre-processing module for generating a first driving signal, and generating a second driving signal according to the first driving signal after the first driving signal is stopped; and
an ultrasonic transmitting/receiving module in communication with the pre-processing module for receiving the first driving signal, and generating vibration and transmitting a sensing wave according to the first driving signal, wherein the second driving signal is received by the ultrasonic transmitting/receiving module after the pre-processing module stops generating the first driving signal, the vibration generated within the ultrasonic transmitting/receiving module is decayed as a decay signal, and the decay signal is offset according to the second driving signal so that a decay time of the decay signal is shortened.

10. The ultrasonic transducer according to claim 9 wherein the first driving signal has a first phase, a first amplitude, a first pulse number and a first frequency, and the second driving signal has a second phase, a second amplitude, a second pulse number and a second frequency.

11. The ultrasonic transducer according to claim 10 wherein the second amplitude is set to be equal to the first amplitude.

12. The ultrasonic transducer according to claim 10 wherein the second frequency is equal to the first frequency, and there is a phase shift between the second phase and the first phase.

13. The ultrasonic transducer according to claim 12 wherein the phase shift is set such that the second driving signal and the first driving signal have different phases or they are out of phase.

14. The ultrasonic transducer according to claim 10 wherein the second frequency and the first frequency are different.

15. The ultrasonic transducer according to claim 10 wherein the second pulse number is preset.

16. The ultrasonic transducer according to claim 10, further comprising:
a microprocessor for processing the first phase and the second phase;
a signal amplitude modulator disposed within the microprocessor for adjusting the first amplitude and the second amplitude; and
a driving circuit disposed within the pre-processing module and in communication with the signal amplitude modulator for outputting the first driving signal and the second driving signal.

17. The ultrasonic transducer according to claim 16 wherein the first frequency, the first pulse number, the second frequency and the second pulse number are set by the microprocessor.

18. The ultrasonic transducer according to claim 16 wherein the ultrasonic transmitting/receiving module comprises:
a transmitter in communication with the driving circuit for receiving the first driving signal, and generating the vibration and transmitting the sensing wave according to the first driving signal; and
a receiver for receiving the reflective wave.

19. The ultrasonic transducer according to claim 18, further comprising a receiving circuit, which is disposed within the pre-processing module and in communication with the receiver, wherein a distance between the ultrasonic transducer and the object is determined according to a time interval from generation of the sensing wave and receipt of the reflective wave.
